(19) United States
(12) Patent Application Publication
(10) Pub. No.: US 2010/0041456 A1
(43) Pub. Date: Feb. 18, 2010

(54) ELECTRONIC GAME

(76) Inventor: Brian M. Yu, Los Angeles, CA (US)

Correspondence Address: CANTOR COLBURN, LLP, 20 Church Street, 22nd Floor, Hartford, CT, 06103, US

(21) Appl. No.: 12/542,467

(22) Filed: Aug. 17, 2009

Related U.S. Application Data
(60) Provisional application No. 61/089,564, filed on Aug. 17, 2008.

(51) Int. Cl. A63F 9/24; A63F 13/00

(52) U.S. Cl. 463/10; 463/30

(57) ABSTRACT

A game for providing gameplay on a display device is provided. The game apparatus includes a game controller that communicates with the display device. The game controller includes a receiving area having one or more game piece slots that receive one or more game pieces, where each game piece slot is associated with a reading device that reads data records retained by the one or more game pieces placed on the one or more game piece slots and that generates game piece input signals. A game processor provides a game having a current game activity that is based on the game piece input signals and transmits output signals to display a representation of the current game activity by the display device.

### CROSS-REFERENCE TO RELATED APPLICATIONS

This application claims the benefit of U.S. Provisional Application No. 61/089,564 filed Aug. 17, 2008, the contents of which are incorporated herein by reference thereto.

### BACKGROUND

Embodiments of the present invention are related to video game consoles and, more particularly, to “plug and play” video game systems for playing games, and methods corresponding thereto.

A dedicated console is a video game console that is dedicated to a built in game or games, and is generally not equipped for additional games, via cartridges or other media. A “plug and play” system operates on either batteries or an electronic power supply and plugs directly into a television set, VCR or other video display system.

Accordingly, it is desirable to provide a game apparatus for playing games on a display screen.

### SUMMARY

In one exemplary embodiment, a game for providing gameplay on a display device is provided. The game apparatus includes a game controller that communicates with the display device. The game controller includes a receiving area having one or more game piece slots that receive one or more game pieces, where each game piece slot is associated with a reading device that reads data records retained by the one or more game pieces placed on the one or more game piece slots and that generates game piece input signals. A game processor provides a game having a current game activity that is based on the game piece input signals and transmits output signals to display a representation of the current game activity by the display device.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The invention, in accordance with preferred and various embodiments, together with further objects and advantages thereof, is more particularly described in the following detailed description taken in conjunction with the accompanying drawings in which:

FIG. 1A is a perspective view illustrating a non-limiting electronic game adapted to provide gameplay for a game in accordance with an exemplary embodiment;

FIG. 1B is a perspective view illustrating a non-limiting game controller of the electronic game adapted to provide gameplay for a game in accordance with an alternative exemplary embodiment;

FIGS. 2A and 2B are perspective views illustrating a non-limiting game pieces used with the game controller to provide gameplay for a game in accordance with an exemplary embodiment;

FIG. 3 is a schematic block diagram illustrating operational components of the example game controller of FIGS. 1A and 1B in accordance with an exemplary embodiment; and

FIG. 4 is a flowchart illustrating an embodiment of a process of playing SCRABBLE using gameplay facilitated by the exemplary electronic game of FIGS. 1A and 1B.

The detailed description explains various embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified.

### DETAILED DESCRIPTION

Exemplary embodiments of the present invention can be implemented to provide for electronic gameplay of a game by one or more participants or players. The game employs plurality of game pieces. Each game piece includes identifiable data, where the data is identified and used to play the game when game pieces are arranged in certain patterns on a receiving area of a game controller. A non-limiting example of the game includes a word game where the data of the game pieces indicates a letter and the pattern is used to spell a word. It being understood that the letters and words may be from any language, such as, for example, French, English, Japanese, Korean, Chinese, Indian, Spanish, Russian, etc.

Alternatively, non-limiting examples of the game can be implemented to provide for electronic gameplay of other games that are played by one or more participants or players using identifiers (e.g., written symbols, characters, indicia, etc.) other than, or in addition to, letters. For example, exemplary embodiments contemplate games that employ data representing written symbols, objects, pictures, exclamations, pieces of music, and/or other particular markings that represent (or stand for) something else by association, resemblance, or convention, (for instance, an object that is used to represent something that does not have a physical form such as an idea, a concepts, or another abstraction). Therefore, various embodiments can provide for electronic gameplay that involves distinct units of written expression that have a particular meaning and are composed of one or more written symbols that determine the particular meaning.

In various embodiments, the game controller is adapted to be manipulated by one or more players. The game controller provides input gameplay signals based on a user's manipulation of one or more selection items. The game controller includes a receiving section or unit adapted to read the data of the game pieces. The receiving area provides symbol signals based on the data read from the game pieces. A game processor integrated within the game controller is adapted to receive the input gameplay signals and signals transmitted from the receiving area. In various embodiments, the game processor is adapted to execute a word game application based on the signals. The word game application determines a current game activity state for the word game and transmits output signals to a peripheral video display device such as, for example, a television set or a computer monitor, for rendering a video representation of the current game activity. The video representation of the game activity can be provided as, for example, a playing grid for the word game rendered for viewing by the players on the peripheral video display device according to the output signals transmitted by the game processor.

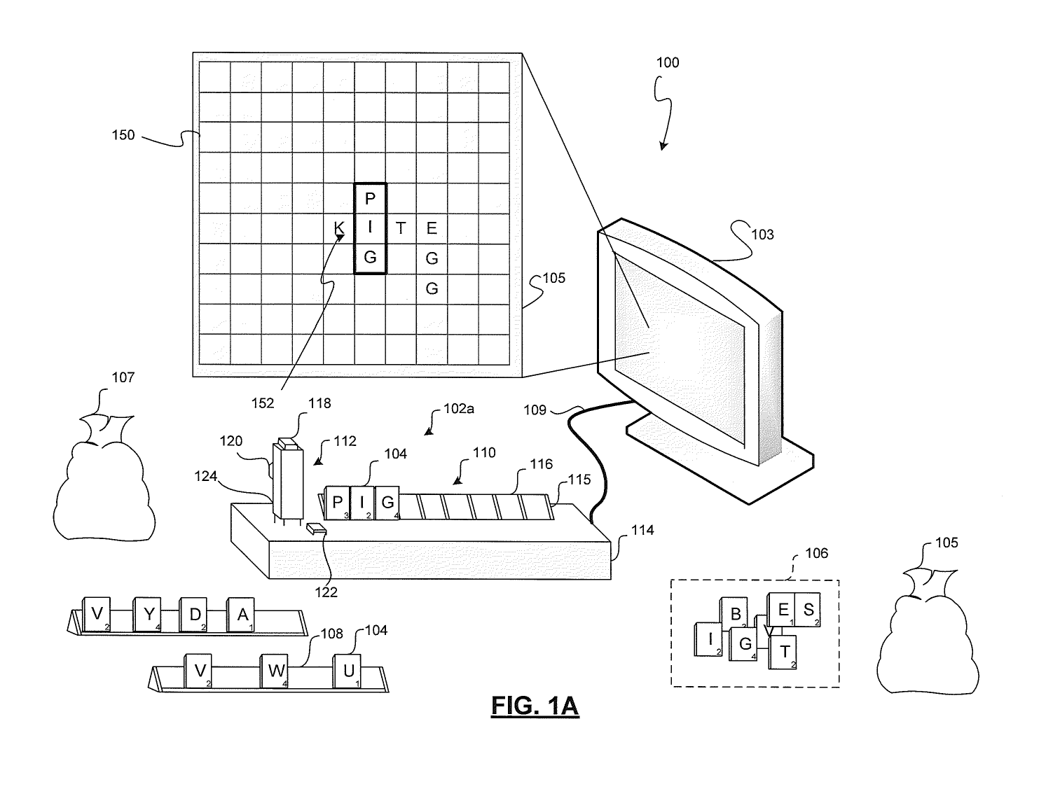

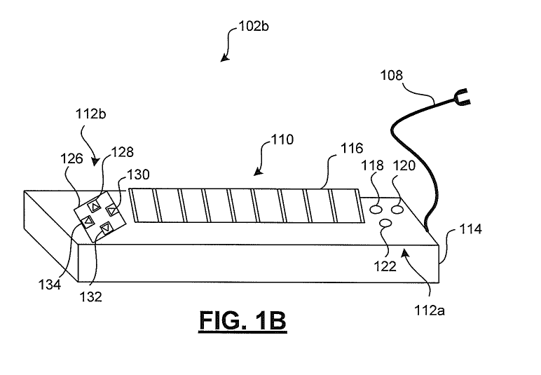

Referring now to FIGS. 1A and 1B embodiments of an electronic game adapted to provide gameplay for a game is illustrated and generally indicated by reference number 100. The electronic game 100 includes a game controller 102a, a display device 103, a plurality of game pieces 104, and one or more storage bags 106, 107 and/or storage trays 108. One alternative embodiment of the game controller 102a is illustrated generally by reference number 102b in FIG. 1B. In various embodiments, the game controller 102a, 102b may be independent of a personal computer or a game console, and may additionally or alternatively be referred to as an interactive electronic game system, as a TV game, or as a “plug and play” game or game system.

The game controller 102a, 102b shown in FIGS. 1A and 1B are configured for use with the display device 103. The display device 103 may be, for example, a television, a monitor, a digital projector with an accompanying screen, or any other suitable display device. As will be discussed in more detail below, the display device 103 receives signals from the game controller 102a, 102b and generates a game display 105.

In one embodiment, the game controller 102a, 102b is configured to directly connect to the display device 103. For example, the game controller 102a, 102b may include cabling 109 for operatively connecting to video and/or audio inputs (not shown) of the display device 103. The cabling 109 may be in the form of, for example, RCA cabling, coaxial cabling, S-video cabling, or any other suitable video or audio/video cabling. In various embodiments, the cabling 109 may be integrally formed with the game controller 102a, 102b. Alternatively, the game controller 102a, 102b may include connectors (not shown) for selectively coupling separate cabling to the game controller 102a, 102b. In embodiments in which the game controller 102a, 102b is configured to utilize separate cabling 109, the game controller 102a, 102b may include connectors for one type of cabling 109, or may include connectors for multiple types of cabling 109, thus enabling the game controller 102a, 102b to be connected to a variety of displays devices 103 depending on the corresponding connection on the display device 103. Alternatively, in various embodiments, the game controller 102a, 102b can be configured to wirelessly transmit data to the display device 103. One non-limiting example is RF or infrared technology comprising receivers and transmitters or any other equivalent technology.

In various embodiments, the game controller 102a, 102b may be configured to operably connect to the display device 103 through one or more peripheral devices (not shown). For example, the game controller 102a, 102b may be connected to the video or audio/video inputs of a peripheral device such as a VCR, DVD player, receiver, or any other appropriate peripheral device with video or audio/video inputs. The peripheral device may in turn be connected to the display device 103. Alternatively or additionally, the game controller 102a, 102b may include a wireless transmitter that wirelessly transmits the output data to a wireless receiver that is directly or peripherally attached to the display device 103.

As shown in FIGS. 1A, the game controller 102a includes a casing 114. The casing 114 can be provided with a substantially flat lower surface that may be adapted to rest on a tabletop or other suitable surface, or in the lap of a player. Of course, other non-flat surfaces are contemplated to be within the scope of the embodiments of the present invention. The casing 114 can also include an upper surface that is opposite from the lower surface and a plurality of side surfaces.

The game controller 102a further includes a receiving area 110 and a controller area 112. The receiving area 110 and the controller area 112 can be integrally formed to the upper surface and/or one or more of the side surfaces of the game controller 102.

The receiving area 110 is adapted to receive the game pieces 104. In various embodiments, the receiving area 110 includes a receiving tray 115 that extends transversely from the casing 114. The receiving tray 115 can include a plurality of game piece slots, ports or receiving areas 116 that each are configured to receive a single game piece 104. Alternatively, the receiving tray 115 can include a single game piece slot, port or receiving area (not shown) that can be configured to receive a plurality of game pieces 104, placed at varying locations. The receiving area 110 is configured to read information retained by the game pieces 104 that are placed on the receiving tray 115 during the course of playing the game.

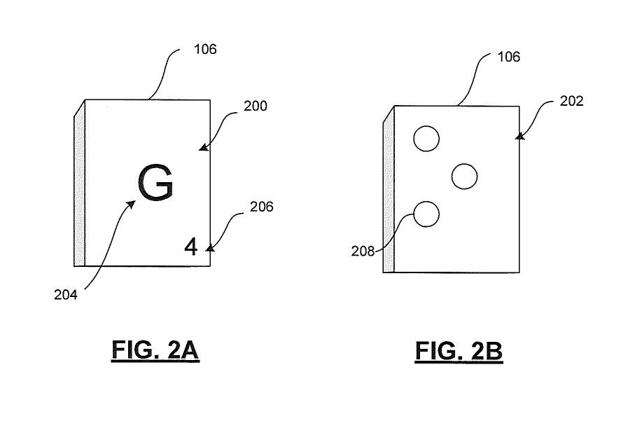

In one example, as shown in FIGS. 2A and 2B, the game pieces 104 each include a first surface 200 and a second, opposite surface 202. The first surface 200 includes one or more visual markings 204, 206 illustrating written symbols used in game play, as well any other game-related information. During game play, the visual markings 204, 206 are used by the player as a reference. For example, in one non-limiting embodiment the game is a word game such as SCRABBLE and the plurality of game pieces 104 are tiles that correspond to the one hundred letter distribution for the game. In this example, each tile includes a visual marking 204 indicative of a particular letter (or blank space) of the SCRABBLE letter distribution and a visual marking 206 of a point total associated with that letter. For instance and as illustrated in FIG. 2A, the game piece 104 is a ‘G’ tile that provides the visual marking 204 of the letter ‘G’ and the visual marking 206 of the number ‘4’ indicating that the tile is worth four points in the game.

The game pieces 104 each include a data record 208 that is indicative of the written symbol and/or other game related information associated with that game piece 104. The data record 208 is read by the receiving area 110 when the game piece 104 is placed on the receiving tray 115.

In one non-limiting exemplary embodiment, as shown in FIG. 2B, the data record 208 includes one or more pegs or electrical pads disposed on the opposite surface 202 of the game piece 104. The one or more pegs or electrical pads are arranged on the second, opposite surface 202 of the game piece 104 in a particular pattern that can be identified by the receiving area 110 and associated with the particular written symbol and/or game related information of the game piece 104.

In another non-limiting exemplary embodiment, the data record 208 is a memory component disposed on the second, opposite surface 202 or disposed within each game piece 104. The memory component can include, but is not limited to, a character encoding used to represent text in computers (such as an American Standard Code for Information Interchange (ASCII) code) for the game piece's associated character. In certain of these embodiments, each of the game pieces 104 can comprise an automated chip card (or smart card) such as a memory card. For example, each game piece may comprise a contact smart card having a readable chip (employing, for example, ROM, flash memory, or solid-state memory) or a contactless smart card employing RFID (radio frequency identification) technology. In yet another non-limiting exemplary embodiment, the data record 208 can include a bar code that can be scanned by the receiving area 110.

It being understood that any other known method of data transfer (e.g., contact, non-contact, direct, etc.) from the game piece 104 to the receiving area 110 may be employed in the exemplary embodiments of the present invention. Other non-limiting methods include Infrared, BLUETOOTH or any other equivalent types of data transfer either wireless or non-wireless or a combination of both.

With reference back to FIG. 1A, the controller area 112 includes one or more input devices 118, 120, 122, 124. As can be appreciated, the input devices 118-124 can include any combination and number of joysticks, gamepads, buttons, paddles, keyboards, mice, trackballs, level switches, contact switches, and other suitable controller devices. As can be appreciated, the controller area 112 can include a single control area as shown in FIG. 1A or multiple control areas dispersed across the upper surface and/or side surfaces of the game controller 102b as shown in FIG. 1B.

In the embodiment illustrated in FIG. 1A, the input devices 118-124 include a first button 118, a second button 120, a third button 122, and a joystick 124. The joystick 124 is a handheld stick that pivotally couples to the upper surface of the game controller 102a. The joystick 124 is thereby tiltable in two dimensions (that is, around two axes) relative to the game controller 102a and is configured to be manipulated by a player grasping the joystick 124. The joystick 124 may include a plurality of switches or other sensors disposed at a first end that are adapted to be depressed or otherwise operated to close a circuit and thereby transmit directional signals. For example, there may be four switches that correspond generally to the directions of up, down, left, and right, and there may be a directional signal corresponding to each of these directions. The joystick 124 may be biased toward a rest position in which the joystick 124 extends substantially perpendicularly from the upper surface of the game controller 102a, and the rest position may correspond to a position in which none of the direction signals are transmitted.

In the present embodiment, the first button 118 is depicted as being incorporated on the joystick 124 and configured to be movable between a rest position and a depressed position by a player grasping the joystick 124. The first button 118 is biased away from the depressed position toward the rest position. When depressed, the first button 118 generates a first actuator signal. For example, the first button 118 may be operatively coupled to a switch that is adapted to provide an open circuit when the first button 118 is in the rest position and a closed circuit when the first button 118 is moved to the depressed position to thereby transmit the first actuator signal. As will be discussed in more detail below, the first button 118, when depressed, generates an actuator signal indicating an enter command.

The second button 120 is depicted as being incorporated on the upper surface of the game controller 102a and configured to be movable between a rest position and a depressed position by a player. The second button 120 is biased away from the depressed position toward the rest position. When depressed, the second button 120 generates a second actuator signal For example, the second button 120 may be operatively coupled to a switch that is adapted to provide an open circuit when the second button 120 is in the rest position and a closed circuit when the second button 120 is moved to the depressed position to thereby transmit the second actuator signal. As will be discussed in more detail below, the second button 120, when depressed, generates an actuator signal indicating a rotate request.

The third button 122 is likewise depicted as being incorporated on the upper surface of the game controller 102a and configured to be movable between a rest position and a depressed position by a player. The third button 122 is similarly biased away from the depressed position toward the rest position. When depressed, the third button 122 generates a third actuator signal. For example, the third button 122 may be operatively coupled to a switch that is adapted to provide an open circuit when the third button 122 is in the rest position and a closed circuit when the third button 122 is moved to the depressed position to thereby transmit the third actuator signal. As will be discussed in more detail below, the third button 122, when depressed, generates an actuator signal indicating a challenge request.

In an alternative embodiment, the controller area 112 includes multiple control areas 112a and 112b that include input devices 118, 120, 122 and 126, respectively. The control area 112b is disposed at a first side of the upper surface of the game controller 102b and includes a gamepad 126. The gamepad 126 includes a plurality of directional buttons 128, 130, 132 and 134. The directional buttons 128-134 are configured to be movable between a rest position and a depressed position by a player. The directional buttons 128-134 are biased away from the depressed position toward the rest position. When depressed, the directional buttons 128-134 generate directional signals. For example, the directional buttons 128-134 may be operatively coupled to switches that are adapted to provide an open circuit when the directional buttons 128-134 are in the rest position and a closed circuit when the directional buttons 128-134 are moved to the depressed position to thereby transmit the directional signals.

The control area 112a is disposed at a second, opposite side of the upper surface of the game controller 102b and includes the first button 118, the second button 120, and the third button 122 that generate the actuator signals as discussed above.

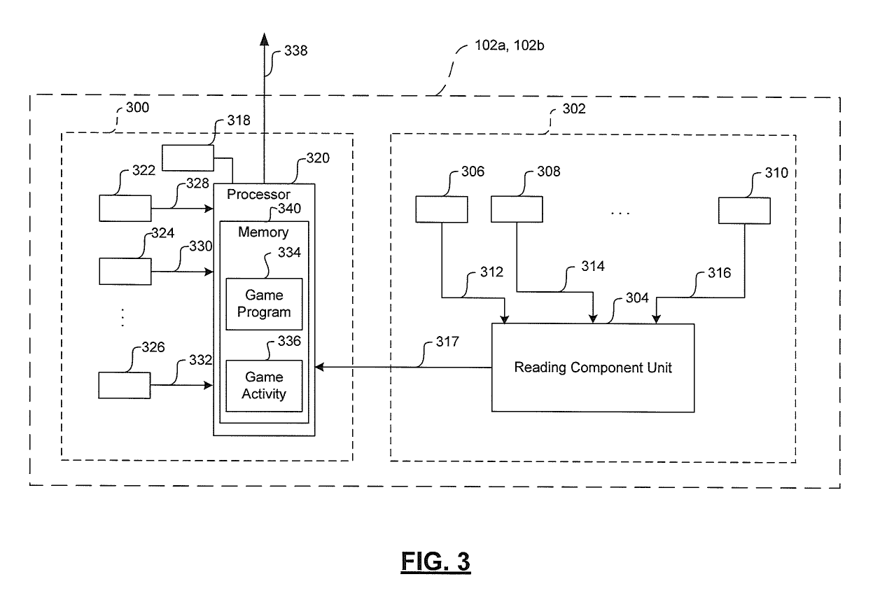

Referring now to FIG. 3, internal components of the game controller 102a, 102b are illustrated in accordance with an exemplary embodiment. The game controller 102a, 102b is shown to include a control unit 300 and a receiving unit 302. The receiving unit 302 includes a reading component unit 304 and one or more reading input devices 306, 308 and 310. The one or more reading input devices 306-310 correspond to the game piece slots 116 (FIG. 1A). As can be appreciated, the reading input devices 306-310 are configured to read or identify the record data 208 of the game piece 104 based on the implementation of the record data 208 as discussed above. The reading input devices 306-310 generate read signals 312, 314 and 316 indicating what was read or identified by the reading input devices 306-310.

The reading component unit 304 receives the read signal 312-316 and associates the read signals 312-316 with a particular symbol or game information. The reading component unit 304 generates a symbol or game piece signal 317 based thereon.

The control unit 300 is operatively and electrically connected to the receiving unit 302. The control unit 300 incorporates each of a power supply 318, a game processor 320, and a plurality of control input devices 322, 324 and 326. The power supply 318 provides power to one or more internal components of the game controller 102a, 102b and may include at least one of one or more batteries, an AC/DC converter, and the like. The plurality of control input devices 322-326 correspond to one or more of the input devices 118-134 (FIG. 1A, FIG. 1B). As discussed above, the control input devices 322-326 may be, for example, switches that generate signals 328-332 based on a manipulation of the associated input device 118-134 (FIG. 1A, FIG. 1B).

The game processor 320 is configured to receive the input signals 317, 328, 330 and 332, to process these input signals 317, 328-332 as directed by a game program 334, and to instantiate, maintain, and update a game activity 336 that represents the current status of gameplay. The game program 334 is customized to incorporate the particular game implemented by game controller 102a, 102b (including the methods of playing a game). The game program 334 may include one or more program modules providing programming code, game parameters, and other information for determining the current game activity state according to the current status of gameplay. As used herein, the term “program modules” can refer to routines, programs, objects, components, data structures, and instructions, or instructions sets, and so forth that perform particular tasks or implement particular abstract data types. As can be appreciated, the program modules can be implemented as software, hardware, firmware and/or other suitable components that provide the described functionality, which may be loaded into memory 340. Aspects of the modules may be written in a variety of programming languages, such as C, C++, Java, etc.

The game processor 320 is further configured to generate output signals 338 representative of the current game activity. The output signals 338 are transmitted to the display device 103 (FIG. 1A), for example, via cabling 109 (FIG. 1A) for rendering the game display 105 (FIG. 1A).

The output signals 338 generated and transmitted by the game processor 320 may include audio and video signals. In the embodiment illustrated in FIG. 1A, the game display 105 provides a predefined grid 150 of cells 152 that constitutes the main gameplay area for a particular word game. The game display 105 may also include appropriate interfaces for providing game related information to the players such as, for example, the score, the team, or player names, and the player having the current turn during gameplay.

The game display 105 is modified throughout gameplay according to the output signals 338 transmitted by the game processor 320 to represent current game activity 336. For example, the cells 152 can be filled with characters of the character distribution to provide words and phrases in the grid 150 horizontally, from left to right, and/or vertically, from top to bottom, during the course of gameplay. The grid 150 may represent, for example, a crossword grid used for a crossword puzzle game. Of course, it should be noted that the word game provided in various embodiments is not limited to the example of games played on playing grids of cells and, furthermore, that, in various embodiments providing word games that do employ playing grids, the playing grid is not limited to the example of crossword grids. In various embodiments, the electronic game 100 can be adapted to provide any number of suitable types and variants of games that are played on any number of suitable types and variants of gameplay areas that can be rendered by the display device 103 according to the output signals 338 transmitted by game processor 320. Other contemplated games include mathematics games wherein the game pieces will have data associated with numbers of the game.

In addition to the gameplay area for the particular game, the output signals 338 generated by the game processor 320 may also include additional information relating to the game activity 336 that may be used as reference by the players in determining the current state of gameplay. Such additional information may include, but is not limited to, virtual representations of player instructions, categories of play, words, playing grids, player and team names, timers, scores, sounds, and the like. This additional information may also include data signals 338 that can be rendered by the display device 103 to provide various other screens on the game display 105 in addition to the gameplay area for the word game. These various other screens may include, but are not limited to, a power up screen that may be provided with a start-up tune and may include graphics, animation, etc. when the game controller 102a, 102b is powered on, and screens used to show game set-up (for example, including player name input, team name input, game choice, etc.). For example, players may interact with the game processor 320 to play through a series of menus or screens to choose particular game modes or to perform other methods of interaction with the game.

When the display device 103 or other device with video or audio/video inputs that are in turn connected to the display device 103 has speakers or external speakers connected to it, the output signals 338 generated by the game processor 320 can include audio signals that are rendered to produce sounds corresponding to various functions for signaling various aspects of the game to the players. For example, a buzzer sound may be used to indicate the expiration of time for a particular turn or round of play.

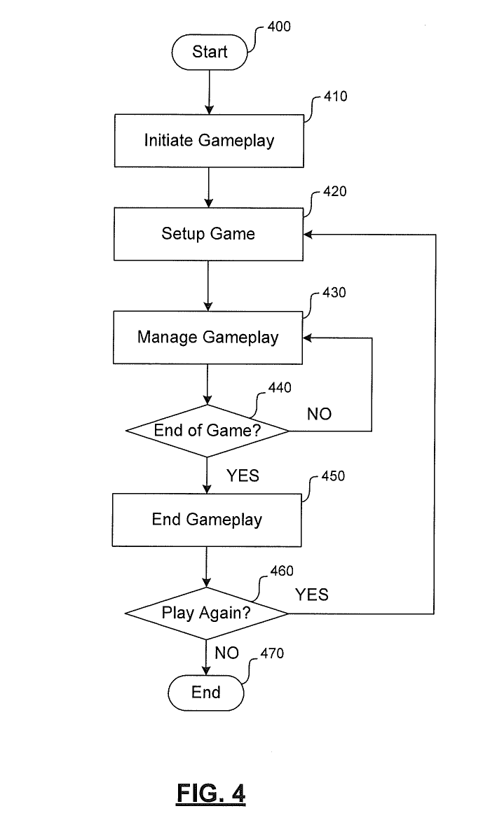

Referring now to FIG. 4 and with continued reference to FIGS. 1A, 1B, and 3, a flow chart depicting an embodiment of a method for an example gameplay facilitated by a non-limiting implementation of the electronic game 100 in which the particular game for which gameplay is provided for by the apparatus is SCRABBLE is illustrated. SCRABBLE is a word game in which multiple players score points by forming words from individual lettered tiles on a game board marked with a defined grid of cells (individually known as “squares”), each of which accommodates a single letter of the SCRABBLE letter distribution. The words are formed across and down in crossword fashion and must appear in a standard dictionary. The object of the game is to score more points than one's opponents.

Of course, it should be noted that, in alternative non-limiting embodiments, the electronic game 100 maybe implemented to facilitate gameplay for any number of other suitable games such as other variations of SCRABBLE or other word games (for example, crossword puzzle games), and other word games that may or may not utilize a playing grid for gameplay. It should also be noted that, in other alternative non-limiting embodiments, the electronic game 100 may be implemented to facilitate gameplay of games that are played using distributions of written symbols that include written symbols other than, or in addition to, written characters, such as objects, pictures, exclamations, pieces of music, numbers, mathematical expressions and furthermore any of the aforementioned are capable of being in any language and/or other particular markings. For example, the receiving area 110 can be adapted to operate as a communication medium between the game pieces 104 and the game processor 320, where the game pieces 104 are each associated with numbers, emoticons, pictures, cartoon images, colors, etc. rather than, or in addition to, letters, as provided for in the written symbols distribution for particular games. Thus, exemplary embodiments of the present invention are not intended to be limited to word games.

In one example, the method may begin at block 400. Gameplay is initiated at block 410, for example, by powering on the game controller 102a, 102b and connecting the game controller 102a, 102b to the display device 103, for example, using cabling 109. Upon connecting the game controller 102a, 102b to the display device 103 gameplay can be initiated automatically or in any suitable manner. For gameplay to be initiated by connecting the game controller 102a, 102b to the display device 103, the display device 103 should also be powered on. When gameplay is initiated, the game processor 320 instantiates a game activity object for maintaining a current game activity 336 (that is, the game activity instance is used to maintain data corresponding to variables reflecting the current status of the game).

At block 420, game setup is performed. During game setup, the game processor 320 receives player input signals 328-332 indicating a number of players that will be playing in the current game. The game processor 320 can also receive input providing player and/or team names. In one example, inputting player and/or team names may be facilitated by the game processor 320 transmitting output signals 338 for rendering the display of a digital version of a keyboard on the display device 103. The player manipulates one or more of the input devices 118-134 to indicate a selected letter on the keyboard.

In another example, inputting player and/or team names may be facilitated by the player placing game pieces 104 that spell the name on the receiving area 110 of the game controller 102a, 102b and manipulating one or more of the input devices 118-134 to indicate the name has been entered. Upon receiving the input data pertaining to the players for a game, the game processor 320 can be configured to determine the order of play using, for example, a pseudo-random number generation module incorporated within game program 334 and/or memory 340.

At block 430, game play begins and is managed by the game processor 320 according to the game program 334. In one example, the game pieces 104 are appropriately mixed in the first bag 106 by a player. The game pieces 104, for purposes of this non-limiting example, comprise letter tiles having data records 208 and visual markings 204 that correspond to a letter (or a blank space) of the letter distribution. A specified number of game pieces are then selected by each player from the first bag 106. The player's letters can be stored on the personal game piece storage tray 108.

The game controller 102a, 102b then provides for gameplay in which the players alternate turns until the game ends. The player whose turn it is (that is, “the current player”) can assume control of the game controller 102a, 102b to play his or her turn. The game processor 320 can be implemented to provide various selectable menus that are rendered on the display device 103 to allow a current player to make selections of gameplay options. The game controller 102a, 102b can be configured to allow the current player to make a selection, for example, by operating the joystick 124 to move the cursor on the display device 103 to a desired option and then selecting that option by depressing one of the first button 118, the second button 120, and the third button 122.

For example, when the current player elects to form a play on the board during a turn, the game processor 320 waits to receive input signals 3 17 corresponding to a word and input signals 322-326 indicating a desired starting cell 152 on the playing grid 150 to play the word from the current player. To provide the input signals 317 for playing a word, the current player selects one or more game pieces 104 that correspond to the word that the player desires to play and places the game pieces 104 on the receiving area 110, with an order of the game pieces 104 corresponding to the spelling of the word. The current player then operates the joystick 124 or the gamepad 126 to move the cursor on the display device 103 to the desired starting cell 152 of the playing grid 150 in which the first letter of the word is to be played and then selects that location by actuating, for example, the first button 118. The game processor 320 can also be configured to prompt the current player to provide input signals 328-332 or otherwise receive input signals 328-332 through manipulation of any one of the input devices 118-134 indicating whether the word should read left-to-right or top-to-bottom beginning at the selected square, where both are options.

The game processor 320 receives the input signals 317 from the receiving area 110 that correspond to data records 208 of the game pieces 104 placed on the receiving area 110, receives the input signals 328-332 from the indicating the starting cell 152 on playing grid 150 where the word is being played, and transmits the output signals 338 to the display device 103 for rendering the letters spelling the word on the playing grid 150.

Upon the selection of the location on the playing grid to play the word by the current user, the game processor 320 processes the play in accordance with the gameplay rules. For example, the game processor 320 can determine whether the word is a proper play and transmit output signals 338 to the display device 103 for rendering a message that the play is not proper and instructing the current player to replay that turn if the word being played is not a proper play. If the word is a proper play, the game processor 320 can determines a score for the play based on the game pieces 104 played, update the game activity 336 accordingly, and transmit the output signals 338 to the display device 103 for updating the rendering of a game score on the game display 105.

In one embodiment, the game processor 320 can also be implemented to allow an opponent player to challenge a word formed by the play by providing a challenge input signal using the game controller 102a, 102b. The challenge input signal can be provided, for example, by an opponent player actuating the third button 122 corresponding to a challenge request. The game processor 320 can be adapted to implement functionality for assessing opponent challenges upon receiving the challenge input signal that determine if the challenged word is acceptable. For example, the game processor 320 can be implemented to make this determination by attempting the locate a match for the word in a data store maintained in the memory 340 containing a list of words found as primary entries in some chosen dictionary, and of their inflected forms. In alternative embodiments, the game processor 320 can be implemented to forgo player challenges and provide for gameplay with automatic word verification, thus making it impossible to play an invalid word. If the game processor 320 determines that a word is unacceptable, the game processor 320 can transmit output signals 338 directing the display device 103 to remove the play from the board and reset the score, and updates the game activity 336 accordingly.

After each player's turn, the game pieces 104 are removed from the receiving tray 115 and placed in the second storage bag 107. At decision block 440, the game processor 320 can then transmit output signals 338 directing the display device 103 to request whether the game has ended, and one of the players operates the input devices 118-134 to transmit input signals 328-332 indicating whether the game has ended. Here the rules of game play prevail wherein the rules may be employed by the users or may be resident upon the game program 334 or combinations thereof. For example in one version of SCRABBLE game play ends when all of the game pieces 104 in the first bag 106 are played or the players cannot play a valid word.

If the player input indicates that the game has not ended at 440, gameplay resumes at block 430. The game processor 320 updates the game activity 336 to register the turn taken, and transmits output signals 338 to the display device 103 for rendering an indication of such. If the player input indicates that the game has ended at block 440, the game is ended at block 450. For example, the game processor 320 can be implemented to determine a final score for the game, update the game activity 336 accordingly, and transmit output signals 338 to the display device 103 for rendering the final score and an indication of the player that won the game.

At decision block 460, in various embodiments, the game processor 320 can also be implemented to transmit output signals 338 to the display device 103 for rendering a selectable option for the players to start a new game. If this option is selected by the players (by providing appropriate input signals 328-332 by manipulating the game controller 102a, 102b), the game processor 320 instantiates a new game activity object and process returns to block 420. If this option is not selected, the method may end at 470.

Some portions of the non-limiting, illustrative embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Various embodiments of the present invention can be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form. Such computer programs can be executed by a computer system to enable the system to perform features of various embodiments of the present invention as discussed herein. A computer program product can be implemented on a computer readable medium, allowing a computer system to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the present application.

What is claimed is:

1. A game for providing gameplay on a display device, the game apparatus comprising:
a game controller that communicates with the display device, the game controller comprising:
a receiving area having at least one game piece slot that receives at least one game piece, the at least one game piece slot being associated with a reading device that reads a data record retained by the at least one game piece when placed on the at least one game piece slot and that generates at least one game piece signal based upon the data record of the at least one game piece on the game piece slot; and
a game processor that provides a game having a current game activity that is based on the at least one game piece signal and that transmits output signals representing the at least one game piece and the current game activity to the display device.

2. The game as in claim 1, wherein the game controller further comprises a controller area that provides a plurality of input signals including at least one actuator signal and a plurality of directional signals, where the game processor determines the current game activity based upon the plurality of input signals.

3. The game as in claim 2, wherein the controller area comprises at least one of a joystick, a gamepad, a button, a paddle, a keyboard, a mouse, a trackball, and a switch that generates at least one of the actuator signal and the plurality of directional signals.

4. The game as in claim 1, further comprises a plurality of game pieces each of the plurality of game pieces retaining a data record.

5. The game as in claim 4, wherein the data record is indicative of at least one of written symbols, written characters, emoticons, pictures, cartoon images, and colors.

6. The game as in claim 5, wherein each of the plurality of game pieces include a visual representation comprising the at least one of written symbols, written characters, emoticons, pictures, cartoon images, and colors.

7. The apparatus as in claim 6, wherein the visual representation includes the written characters, and wherein the written characters are included in a predefined character distribution.

8. The game as in claim 1, further comprising a first game piece storage bag, and a second game piece discard bag.

9. The game apparatus as in claim 1, wherein the reading device is configured to read the data record that includes at least one of a bar code, a character encoding, an electrical pad, and a peg.

10. The game apparatus as in claim 1, wherein the game controller is configured to directly couple to at least one of the display device and a peripheral device.

11. The game apparatus as in claim 1, wherein the game controller is configured to wirelessly transmit the output signals to the display device.

12. The game apparatus as in claim 1, wherein the game includes SCRABBLE.

13. A game for providing gameplay on a display device, the game comprising:
a plurality of game pieces that each retain a data record associated with a written character of a predefined character distribution;
a receiving area that includes at least one game piece slot that receives at least one game piece of the plurality of game pieces, and that has at least one reading component that reads the data record of the at least one game piece and generates at least one game piece signal;
a controller area that includes at least one input device, the at least one input device providing a plurality of input signals including at least one actuator signal and at least one directional signal; and
a control unit that receives at least one game piece signal from the receiving area and that receives the plurality of input signals from the controller area, and that includes a game processor that provides a word game having a current game activity that is based on the at least one game piece signal and the plurality of input signals, and the game processor transmits at least one output signal to represent the current game activity on the display device.

14. The game of claim 13, wherein the current game activity is displayed on a playing grid.

15. The game as in claim 13, wherein the game processor comprises one or more processors configured to be controlled by one or more game modules to provide the word game and to determine the current game activity.

16. The game as in claim 13, wherein the controller area includes the at least one input device selected from joysticks, gamepads, buttons, paddles, keyboards, mice, trackballs, level switches, contact switches, and combinations thereof, and wherein the controller area provides the plurality of input signals according to manipulation of the at least one input device.

17. The game as in claim 16, wherein the at least one input device includes a joystick and a first button, wherein the controller area provides the at least one directional signal according to manipulation of the joystick, and the controller area provides the at least one actuator signal according to manipulation of the first button.

18. The game as in claim 13, wherein the current game activity is displayed on a playing grid, the game processor is implemented to determine a location on the playing grid according to the at least one directional signal, wherein the game processor is implemented to correlate the at least one game piece signal from the receiving device to written characters, and wherein the game processor is implemented to transmit the at least one output signal to display a word including the written characters sequentially at the location on the playing grid.

19. The game as in claim 18, wherein the game processor is implemented to determine whether the word corresponds to a proper play according to a set of predetermined rules for the word game, where the set of predetermined rules are stored on a data storage unit accessible by the game processor.

20. The game as in claim 18, wherein the current game activity includes a current game score, and the game processor is implemented to update the current game score according to the word and the location on the playing grid and implemented to attempt to locate the word in a predetermined list of acceptable words for the word game.
